(19) United States
(12) Patent Application Publication
(10) Pub. No.: US 2019/0251129 A1
(43) Pub. Date: Aug. 15, 2019

(54) WEB ACCESS ENHANCEMENT

(71) Applicant: VE GLOBAL UK LIMITED, London (GB)

(72) Inventor: Florian BARBARE, London (GB)

(21) Appl. No.: 16/331,698

(22) PCT Filed: Sep. 11, 2017
(86) PCT No.: PCT/EP2017/072713

§ 371 Date: Mar. 8, 2019

(30) Foreign Application Priority Data
Sep. 9, 2016 (GB) 1615327.2

(51) Int. Cl. G06F 16/954; G06F 16/957; G06F 16/955

(52) U.S. Cl. CPC G06F 16/954; G06F 16/955; G06F 16/9574

(57) ABSTRACT

There is described a technique for controlling a web browser, comprising: navigating from a first web page address to a second web page address; manipulating a browser history associated with the web page; and detecting an operation to navigate back in the manipulated web browser, and in dependence thereon initiating an application associated with the web page.

### BACKGROUND TO THE INVENTION

### Field of the Invention

The present invention relates to an arrangement in which a 3^{rd} party software application is provided in conjunction with a user accessible website, the 3^{rd} party software application being provided to enhance the services provided by the website to the user. It is particularly concerned with detection of selection of an operation to navigate backwards to a previous web page, for example using a ‘back button’ in a browser.

### Description of the Related Art

In a computer network, user computing devices may access websites associated with web applications hosted by web servers. The websites offer various functionality to the users accessing them. A user web experience can be understood as a journey. During a journey the user can access various web pages associated with one website, and also access web pages in other domains via the website, such as a payment web page in a different domain. A user may perform multiple journeys in the web browser of their computing equipment at the same time.

It is known to provide 3^{rd} party software applications which can be used to enhance the services provided by a website to users. The 3^{rd} party software applications may not be visible to the user as being provided by a 3^{rd} party.

An example of a 3^{rd} party software application is the provision of functionality on initiation of exiting (i.e. closure) of a web page by a user. Rather than exiting the web page, on initiation of closure of the web page the 3^{rd} party software application may intervene and seek the user's confirmation that the closure of the web page should be enacted. Such techniques are known in the art to improve user engagement with websites.

Existing techniques may not allow all mechanisms by which a web page can be exited to be detected, thus preventing initiation of a 3^{rd} party software application in some circumstances. For example if a user, through a browser of their computing device, selects a ‘back button’ on the browser then detection of exiting of the website through closure of a web page of the website may not be possible.

It is an aim of the invention to provide an improvement.

### SUMMARY OF THE INVENTION

In an aspect the invention provides a method of controlling a web browser, comprising: navigating from a first web page address to a second web page address; manipulating a browser history associated with the web page; and detecting an operation to navigate back in the manipulated web browser, and in dependence thereon initiating an application associated with the web page.

The step of manipulating the browser history may comprise creating at least one additional browser history entry.

The step of manipulating a browser history associated with the web page may comprise creating an iFrame and an iFrame history for the web page. The method may comprise creating the iFrame at a first address, and navigating the iFrame to a second address. The method may further comprise creating the iFrame on navigation of the web page from the first web page address to the second web page address. On a back navigation in the web browser, the iFrame may load the first iFrame address. Detecting the operation to navigate back in the web browser may comprise detecting loading of the first iFrame address. Detecting the operation to navigate back in the web browser may comprise detecting navigation of the iFrame from the second iFrame address to the first iFrame address.

The step of manipulating the browser history associated with the web page may comprise creating at least one additional entry in a web page browser history for the web page. The step of manipulating the browser history may comprise creating two additional web page browse histories. On a back navigation in the web browser the web page history may move from a second created additional entry to a first created additional entry.

In response to initiation of the application associated with the web page, the web page may be maintained at the second address.

In response to initiation of the application associated with the web page, the web page may be navigated to the first address.

In an aspect there is provided a method of controlling a web browser comprising: navigating from a first web page address to a second web page address; creating an iFrame in dependence on navigation to the second web page address; navigating from a first address of the iFrame to a second address of the iFrame; in dependence on detecting navigation from the second address of the iFrame to the first address of the iFrame, initiating an application associated with the second web page.

The step of navigating to the second web page address from the first the web page address may increment the web browser history by one, creating the iFrame creates an iFrame history and navigating the iFrame to a second address may increment the iFrame history by one.

On initiation of a back operation in the web browser the iFrame history may be decremented and the web browser history is decremented.

Navigation from the second address of the iFrame to the first address of the iFrame may be indicative of a back operation.

Loading of the first address of the iFrame may denote navigation from the second address of the iFrame to the first address of the iFrame.

A pointer position of an iFrame browser may denote navigation from the second address of the iFrame to the first address of the iFrame.

The method may further comprise, in dependence on detecting navigation from the second address of the iFrame to the first address of the iFrame, suspending operation of the web browser.

Initiating the application may comprise requesting confirmation that the second web page is to be closed, wherein of such confirmation is provided the method further comprises navigating from the second web page to the first web page, and deleting the iFrame.

An aspect provides a method of controlling a web browser, comprising: navigating from a first web page address to a second web page address; sequentially creating at least one further instance in a web page browser history after creation in the web page browser history of an entry for navigation to the second web page address; and in dependence on detecting navigation from the at least one further instance in the web page browser history, initiating an application associated with the second web page address.

The step of sequentially creating may comprise creating first and second instances, the method comprising initiating the application in dependence on detecting navigation from the second instance to the first instance. Said navigation is detected in dependence on detecting a browser history pointer changing from pointing to the second instance to pointing to the first instance.

The step of creating at least one further instance in the web page browser history may comprise creating a first browser history entry to extend the browser history beyond navigation to the second address of the web page, wherein a browser sequence is from the second address of the web page to the first created browser history. The step of creating at least one further instance in the web page browser history may comprise creating a second browser history entry to extend the browser history beyond navigation to the first browser history entry, wherein a browser sequence is from the first created browser history to the second created browser history.

The step of creating at least one further instance in the web page browser history may comprise creating a first instance of an additional browser web page history after the web page browser history is modified on creation of the second web page, and creating a second instance of an additional web page browser history after creation of the first instance.

A URL associated with the first instance and the second instance may be the URL of the second address of the web page.

Directing navigation from the at least one further instance may comprise detecting a change in a web browser pointer position.

The method may further comprise detecting that the pointer has moved from pointing to the second instance to pointing to the first instance.

On initiation of a back operation the web page may be navigated to the first address. The web browser pointer maybe adjusted to point to the first web page address.

On initiation of a back operation the web page may be maintained at the second address.

A web browser pointer may be adjusted to point to the second web page address.

Detecting navigation from the at least one further instance may comprise monitoring the name of the at least one further instance, wherein in dependence on the browser moving from the name of the at least one further instance the application associated with the second web page address is initiated.

In dependence on the browser moving from the name of the second instance to a name associated with the first instance the application associated with the second web page address is initiated.

The method may further comprise detecting a change to the name of the at least one further instance, and in dependence thereon monitoring the changed name.

The method may further comprise detecting a change to the name of the second instance, and in dependence thereon monitoring the changed name of the second instance.

Upon the browser refreshing or reloading a web page, if the browser is currently pointing to the first instance, then the second instance may be created.

Upon the browser refreshing or reloading a web page, if the browser is currently pointing to the second instance, no further action may be taken.

Upon the browser refreshing or reloading a web page, if the browser is currently pointing to anything other than the first or second instance, then the first instance may be created followed by the second instance being created.

Aspects additionally provide a computer device configured to perform any described method. A computer device may be any one of a user device, a mobile device, a computer, a laptop computer; a tablet; or a mobile phone.

### BRIEF DESCRIPTION OF THE FIGURES

There is further described arrangements with reference to the accompanying drawings, in which:

FIG. 1 is a general network illustration of client computing devices and web servers, in which web pages are displayed to users at browsers associated with the computing devices;

FIG. 2 is an exemplary illustration of the connection between a web server providing a website which is accessed by a browser of a computing device, which web service is enhanced by the provision of services from a 3rd party software application;

FIGS. 3(a) to 3(d) illustrate an exemplary web page creation in a first technique;

FIGS. 4(a) to 4(d) illustrate exemplary history manipulation in the first technique;

FIG. 5 illustrates exemplary creation of a second web page in the first technique;

FIG. 6 illustrates exemplary handling of a back command in the first technique;

FIGS. 7(a) to 7(d) illustrate exemplary web page creation in a second technique;

FIGS. 8(a) to 8(d) illustrate exemplary history manipulation in the second technique;

FIG. 9 illustrates exemplary creation of a second web page in the second technique;

FIG. 10 illustrates exemplary browser history manipulation in the second technique;

FIG. 11 illustrates exemplary handling of a back command in the second technique;

FIGS. 12(a) to 12(c) illustrate alternative web page creation in accordance with the second technique;

FIGS. 13(a) to 13(c) illustrate exemplary browser web page history corresponding to FIGS. 12(a) to 12(c);

FIG. 14 illustrates an alternative web page creation in accordance with the second technique;

FIG. 15 illustrates an exemplary browser web page history corresponding to FIG. 14;

FIG. 16 illustrates an exemplary process for handing name changes in a modification of the second technique;

FIG. 17 illustrates an exemplary process for handling page reloads or refreshes in a modification of the second technique; and

FIG. 18 illustrates an exemplary computing device configured to perform the described processes.

### DESCRIPTION OF THE PREFERRED ARRANGEMENT

The invention is described in the following with reference to non-limiting examples and exemplary arrangements, which are referred to for the purpose of explaining the invention.

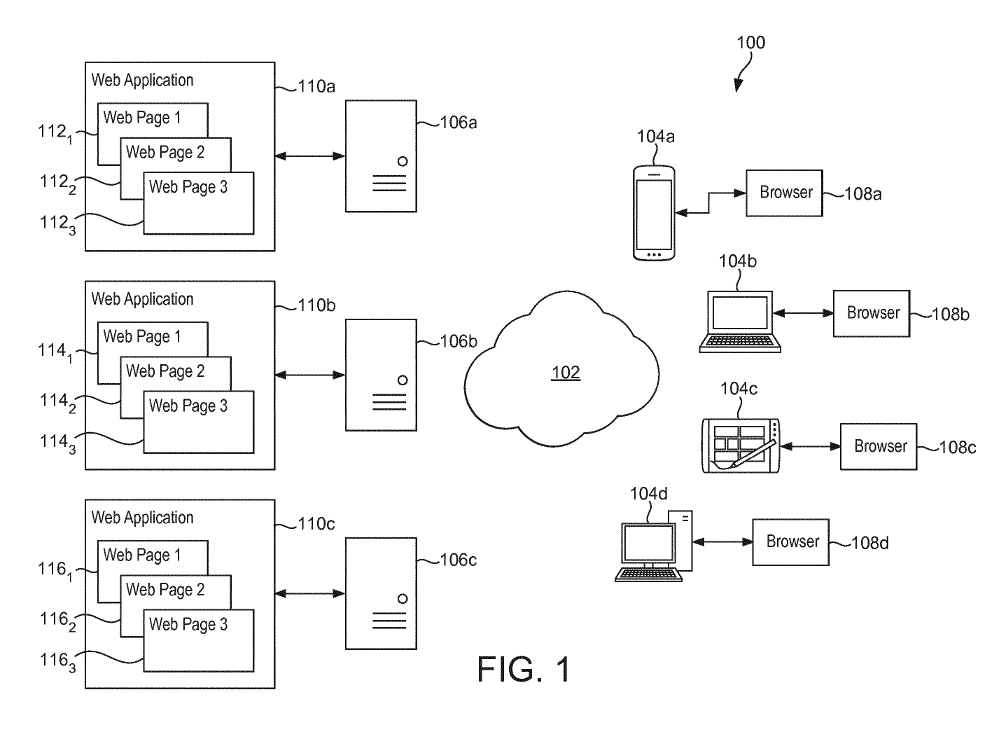

FIG. 1 shows an exemplary high level system architecture 100 consisting of example client-side computing devices 104a, 104b, 104c, 104d capable of communicating with example web servers 106a, 106b, 106c via a network 102.

The examples of client-side computing devices shown are a smart phone 104a, a laptop computer 104b, a tablet 104c, and a desktop computer 104d. A selection of computing devices are shown to illustrate that the present technology may operate with different client-side computing devices. The system may include client-side computing devices in addition to or instead of those shown.

Each computing device 104a to 104d may include a browser application, or browser, respectively identified by respective reference numerals 108a to 108d. The operation of browsers are known, but in general the computing devices 104a to 104d each run a version of a browser as part of their operating system, capable of accessing and retrieving web pages from web servers such as servers 106a to 106c. The browser on each computing device retrieves an electronic document, or web page, from a web site, e.g. associated with one of web servers 106a to 106c, and displays the web page on a monitor, screen or other output mechanism associated with it.

To view the electronic document as a web page, the user specifies a URL (Uniform Resource Locator) identifying the particular document in the browser. A URL may be specified, for example, by entering a URL character string using a user interface, by selecting a hyperlink specifying the URL in a HTML (HyperText Markup Language) document currently being displayed in the browser, or by selecting a hyperlink from a list provided by the browser. In response to the entered URL, the browser generates a request command for the URL and transmits the request over a network to fetch the documents using conventional internet protocols, such as HTTP (Hypertext Transfer Protocol).

Servers 106a to 106c are examples of computing devices configured to host web pages. Each web page is rendered as a part of a web application 110a to 110c, which comprise respective web pages. Illustrated are three web applications 110a to 110c each shown as having three web pages: 112₁ to 112₃; 1141 to 114₃; and 116₁ to 116₃ respectively. Each web application 110a to 110c may have a single web page or multiple web pages, and the illustration of three web pages is not limiting. While three web servers are shown, the present technology may operate with a single server or more than two servers. Any single server may host web pages from one or more web applications, some or all of which may collaborate with each other. Web applications which cooperate with each other may be spread across different servers. All variations as known in the art are encompassed.

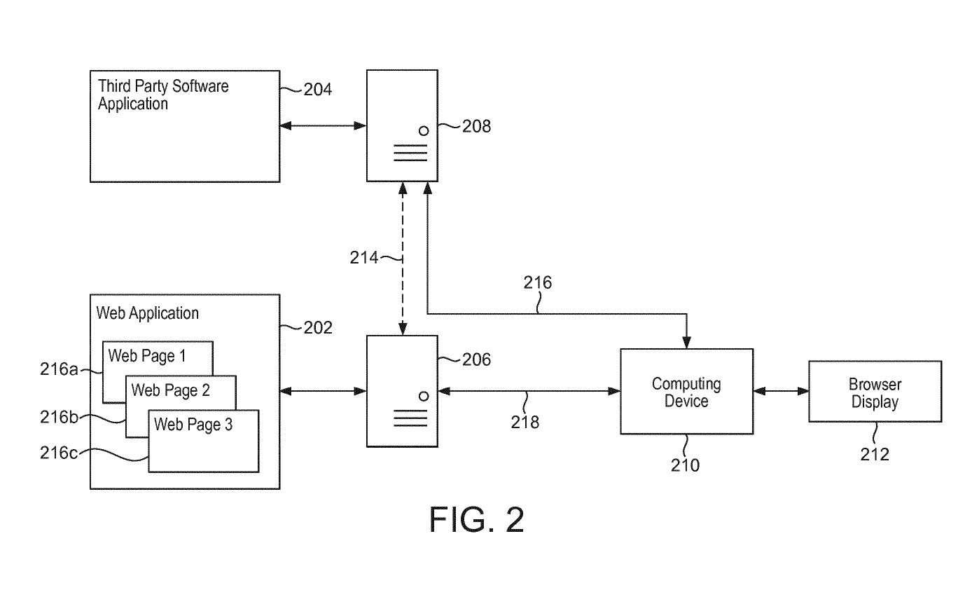

FIG. 2 illustrates an exemplary arrangement in which a 3^{rd} party software application is provided to a website, to offer additional functionality to a user when browsing the website. A website is associated with a web application 202 hosted by a server 206, and includes a plurality of web pages denoted by reference numerals 216a to 216c. A 3^{rd} party software application 204 is hosted by a server 208.

A bi-directional dashed line 214 indicates a communication between the servers 206 and 208, which communication establishes a relationship between the web application and the 3^{rd} party application at some time prior to delivery of a web page. The 3^{rd} party application can provide additional 3^{rd} party services to the offerings of the web application based on an agreement between the 3^{rd} party application and the web application. The communication between the servers 206 and 208 may be provided by a network such as the Internet. Establishing of such a relationship is known.

A computing device 210 associated with a user is in communication with the server 206 to access the website associated with the web application 202. A bi-directional line 218 indicates communication between the server 206 and the computing device 210, which may be provided by a network such as the Internet. The computing device 210 is associated with a browser, with a browser display 212 displaying the browser to the user (or client), for example using a display of the computing device 210.

The browser associated with the computing device 210 makes a request for a web page from the server 206 by sending a request on communication line 218. In response thereto, the server 206 returns an associated web page to the computing device 210 for display by the browser in browser display 212.

The web page delivered by the server 206 to the computing device 210 includes control scripts. In this example it is assumed that the web application 202 is associated with a 3^{rd} party software application 204.

These scripts will therefore include instructions relating to the 3^{rd} party software application as it is to be used in conjunction with the delivered web page.

In the present example, it is assumed that the web page is associated with the 3^{rd} party application 204, and the delivered web page includes in its scripts an instruction to the computing device 210 to fetch additional information from the 3^{rd} party software application 204. Thus on receipt of the web page, the computing device 210 additionally communicates with the server 208 on a bi-directional communication line 216 to retrieve the 3^{rd} party application (or applications) associated with the web page. The communication between the server 208 and the computing device 210 may be provided by a network such as the Internet. Such a communication is known.

An example of a service which the 3^{rd} party software application may provide is to detect when a user exits (initiates closure) of a page of the website associated with the web application, and rather than to allow the immediate closure of that page to instead launch an instance of a service associated with the 3^{rd} party software application. This may be, for example, to generate a message for display to the use to prompt them to confirm that they wish to leave the web page, and may for example comprise offering a voucher to the user if they choose to stay on the web page rather than exit. This is an example of a service which may be offered by the 3^{rd} party software application, but the service offered is non-limiting.

The user may then navigate the website associated with web application 202, and functionality associated with the 3^{rd} party software application may be implemented.

This description is concerned with the triggering of the 3^{rd} party software application to launch a particular functionality on detection that a user is exiting a website (or, more generally, exiting a journey). More specifically, this description is concerned with detecting an exit due to a ‘back’ operation and the consequential triggering of the 3^{rd} party software application.

A user may exit a web page by specifically closing the web page, but may also exit the web page by navigating backwards within the browser to go from a current web page address to a previous web page address. An example of this backwards navigation is selecting the ‘back button’ on the browser, but the backward navigation may also be achieved other ways, for example utilising a keyboard short cut. In the following, reference will be made to selection of a back button on a browser, but this is only an example way of achieving a back operation.

Thus a web page may be exited by a user by selection of the ‘back button’ on the browser, and not only by specific selection of an exit option.

As noted in the background above, a user may conduct a journey in accessing a web site. A journey refers to a user web experience, which may involve the user opening and closing web pages. During the journey the user may access domains other than the domain of the website they are viewing, for example in order to pay for a purchase they are making from a website. During this journey the user may open multiple pages associated with the same website in their browser, and web pages of other websites to which they are directed.

The closure of one web page does not necessarily mean that the user has finished their journey. They may for example have other pages open associated with the website, or other pages open from which they have been directed to by the website and link in to their journey. The closure of one page for the website may therefore still mean that at least one other (or multiple other) page of the website, or more generally at least one other page associated with the same journey, is still open in the user browser.

In the following example, it is assumed that in going back to a first website address from a second website address a 3^{rd} party software application is triggered, whether or not the user is then leaving their journey. In alternatives an extra level of checking can be added to identify whether a back operation is between two web pages of the same journey, and only triggering the third party application if the transition would exit the journey. It may be possible to identify whether the web pages are associated with the same journey based on a journey identifier allocated to each web page.

In some implementations, the journey may be restricted to a particular website, and thus the closure of the final page of the website may indicate the end of the journey. Thus a basic operation which transitions the web page from one domain to another may trigger a 3^{rd} party application.

In arrangements, some but not all of the web pages may be associated with the 3^{rd} party software application, such that there are some web pages of a website which may not be associated with the 3^{rd} party application. Thus in some implementations the service associated with the 3^{rd} party software application is triggered only on a back operation from a web page which is associated with the 3^{rd} party software application.

In the described example, for illustration a process associated with a 3^{rd} party software application is triggered whenever selection of a back operation is detected for a web page address associated with that 3^{rd} party software application. However it will be understood that this may be further adapted so that the triggering of the 3^{rd} party software application is in dependence on whether the web page address being navigated back from is the last open for a particular journey, and further in dependence on any technique being applied only for selected pages in dependence on whether they are associated with the 3^{rd} party application. There may be multiple 3^{rd} party applications, and/or multiple instances of 3^{rd} party applications, and the described technique may be associated with each 3^{rd} party application and/or each instance.

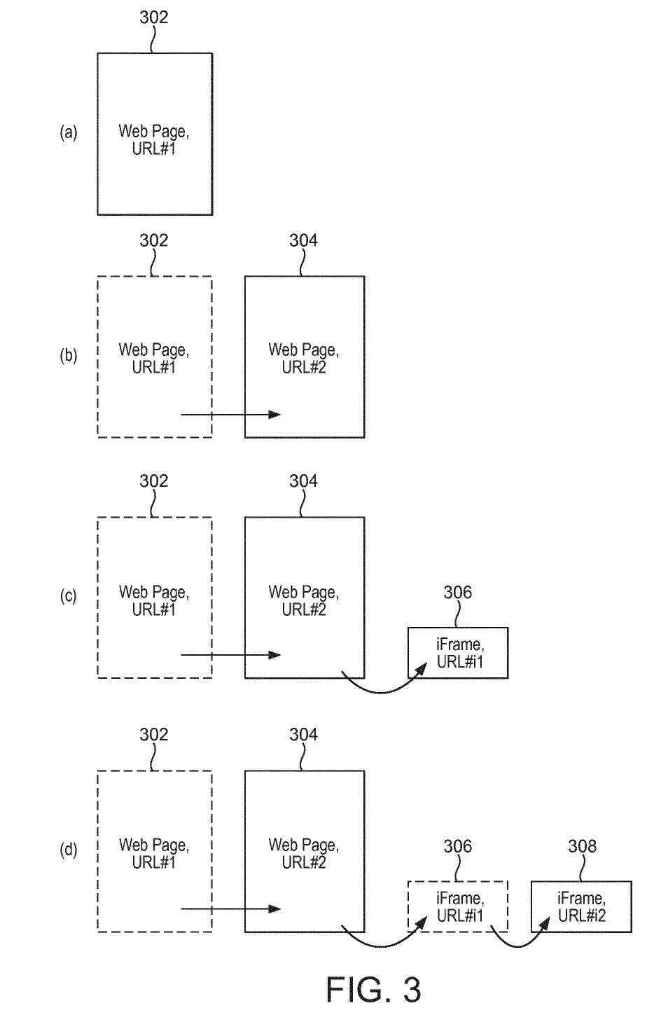

A first technique on determination of a back operation is described with reference to FIGS. 3 to 6.

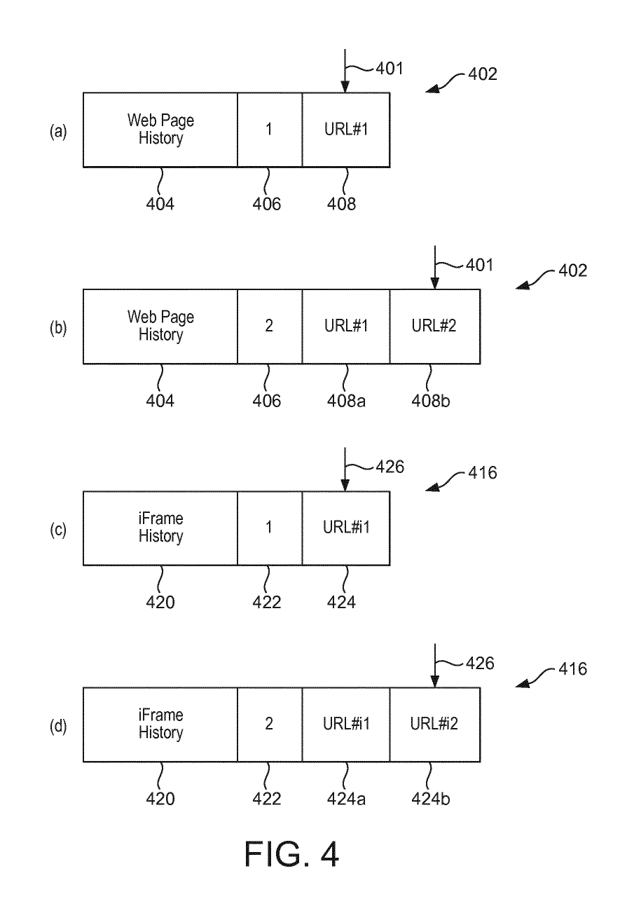

With reference to FIG. 3(a) there is shown a first web page 302, having a web address of URL#1. Referring to FIG. 4(a) there is shown the web page history parameter 402 which is stored by the browser. The browser identifies the web page history by referencing this parameter, and the value with which it is associated. As shown in FIG. 4(a), with one web page open the browser identifies the web page history as having a value of 1. The web page history parameter 402 has a first field 404 identifying the parameter as web page history, a second field 406 identifying the page history value (1), and a third field 408 identifying the URL address (URL#1) associated with the page history of 1, in this case the URL of the current web page. A pointer denoted by arrow 401 points to the address of the current web page, URL#1 in the third field 408.

On receipt of an instruction from a browser to open a new web page address, which is based on a selection of an option within the current web page address, such as a selection of a link within the current web page address, a new web page address is opened in the browser. This is shown in FIG. 3(b). In FIG. 3(b) the first web page address 302 is shown in dashed lines, and it is replaced by a second web page address 304 having URL#2, which is opened from URL#1. Thus from a first web page address a second web page address is opened.

With reference to FIG. 4(b), the web page history parameter 402 is modified. The page history parameter 402 has the first field 404 identifying the parameter as web page history, the second field 406 identifying the web page history value (now 2), and a third field 408 identifying the URL addresses associated with the history. There are now two addresses (URL#1, URL#2) associated with the history, and thus the history field 408 has two sub-fields 408a and 408b. The sub-field 408b is the current address of the web-page, and the sub-field 408a the address of the web-page preceding that. The pointer 401 points to sub-field 408b as the address of the current web page. The browser, on selection of the second web page address from the first web page address navigates to this second web page address as shown in FIG. 3(b), whilst the page history in the browser is updated in this way.

In addition, a modification is made such that on navigating to the second address an iFrame is automatically created in the browser of the device 210.

iFrames have their own history, and thus there is provided a browser iFrame history. The creation of the iFrames does not affect the history of the browser web page history parameter as above, as the main browser history is unaffected by the creation of an iFrame.

Thus, with reference to FIG. 3(c), an iFrame having an address of URL#i1 is created. As shown in FIG. 4(c), there is shown an iFrame history parameter 416 which is stored by the browser. The browser identifies the iFrame history by referencing this parameter, and the value with which it is associated. As shown in FIG. 4(c), with the iFrame created the browser identifies the iFrame history as having a value of 1. The iFrame history parameter 416 has a first field 420 identifying the parameter as iFrame history, a second field 422 identifying the iFrame history value (1), and a third field 424 identifying the URL address (URL#i1) associated with the iFrame history of 1, in this case the URL of the current iFrame. A pointer denoted by arrow 426 points to the first address of the iFrame URL#1.

In accordance with this modification, the iFrame is then navigated to a second address of URL#i2. As shown in FIG. 3(d), the iFrame thus displays the second address as denoted by reference numeral 308. The iFrame 306 is now shown in dashed lines as only one iFrame exists, but with the URL changed.

With reference to FIG. 4(d), the iFrame history parameter 416 is modified. The iFrame history parameter 416 has the first field 420 identifying the parameter as iFrame history, the second field 422 identifying the iFrame history value (now 2), and a third field 424 identifying the URL addresses associated with the history. There are now two addresses (URL#i1, URL#i2) associated with the history, and thus the history field 424 has two sub-fields 424a and 424b. The sub-field 424b is the current address of the iFrame, and the sub-field 424a the previous address of the iFrame. The pointer 426 points to sub-field 424b as the current address of the iFrame. The browser, on selection of the second iFrame address from the first iFrame address navigates to this second iFrame address as shown in FIG. 3(d), whilst the iFrame history in the browser is updated in accordance with FIG. 4(d).

The iFrames are not visible to a user. The web addresses of the two iFrames are however preferably chosen so as to allow each iFrame to be loaded quickly. The web addresses of the two iFrames, URL#i1 and URL#i2, are not important insofar as they are not required to have specific values.

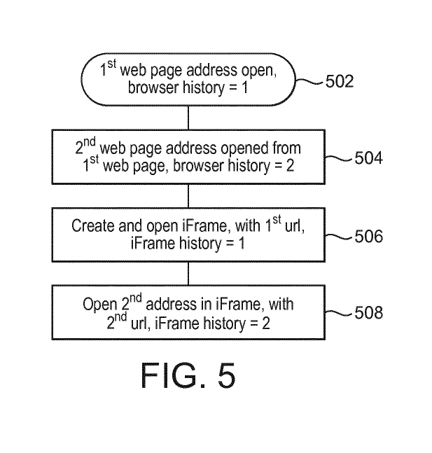

With reference to FIG. 5 there is illustrated the process involved in opening a second web page from a first web page.

As denoted by a step 502, the process commences with the web page open at the first address. The web page history is set at 1. In step 504 the web page is opened at the second address, and the web page history is set at 2. Then in step 506 the iFrame is opened at the first iFrame address and the iFrame history set at 1, and in step 508 the second address of the iFrame is opened, and the iFrame history set at 2. Thus following the process of FIG. 5 the browser history of FIG. 4(b) and of FIG. 4 (d) is established for, respectively, the web page and the created iFrame.

Thus, in sequence: (i) the web page is opened at a first address; (ii) in dependence on a selection on the web page, the web page is navigated to a second address from the first address; (iii) an iFrame is opened at a first iFrame address; and (iv) the iFrame is navigated to a second iFrame address.

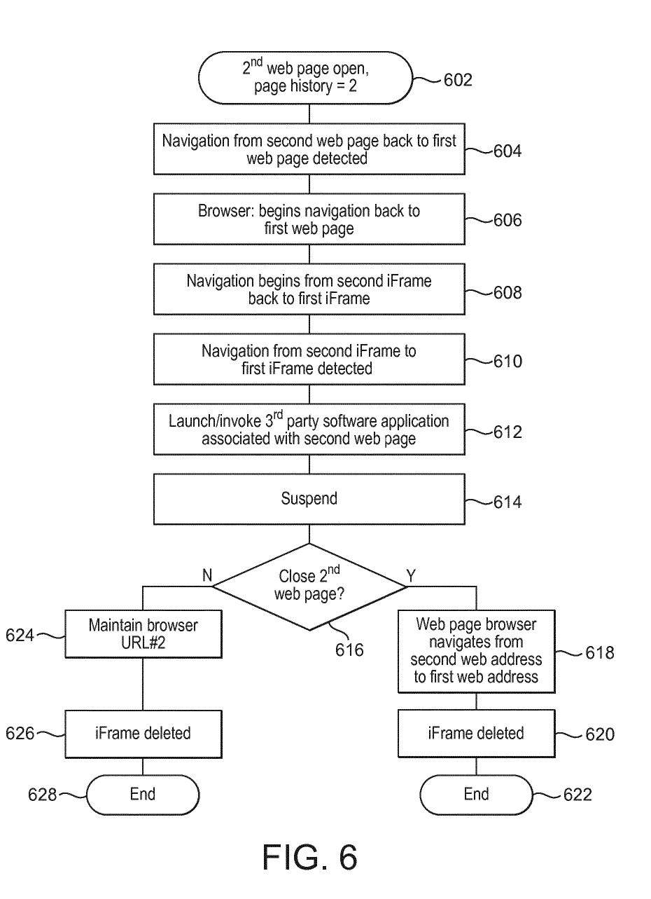

With reference to FIG. 6 there is now illustrated the exemplary process involved in moving back to the first web page address from the second web page address on a back operation.

The process commences, as represented by step 602 with a second web page address open. This second web page address has been opened from a first web page address in line with the foregoing description. The browser web page history is set to 2, and the browser iFrame history is set to 2.

In a step 604, an instruction to navigate back to the first web page address from the second web page address is received at the browser. This may be an instruction received by selection of a ‘button’ on the browser, may be an instruction received by selection of a shortcut key (or key combination) on a keyboard associated with the browser, or may be some other form of back control operation.

In a step 606, the browser begins the process of navigating back from the second web page address to the first web page address for the web page based on the web page history.

In view of the creation of the iFrame as denoted by step 608, a navigation commences for the iFrame from the second iFrame address to the first iFrame address based on the iFrame history. Steps 606 and 608 although shown in FIG. 6 as sequential may be initiated substantially in parallel.

The navigation is based on the web page history in the browser and the iFrame history in the browser. With respect to FIGS. 4(c) and 4(d), the browser moves the pointer 426 in the iFrame history from field 424b to field 424a. At the same time, a navigation commences for the web page and the browser moves the pointer 401 in the web page history from field 408b to field 408a, i.e. from the second web page address to the first web page address. This is based on the histories of FIG. 4(a) and FIG. 4(b) respectively.

The addresses (URLs) for the iFrame are chosen so that they load quickly relative to the addresses of the web page. Thus the iFrame URL#i1 address will load before the web page URL#2 address has started unloading. Whilst as noted above the iFrame addresses URL#i1 and URL#i2 are unimportant, what is important is that they are addresses which can load quickly (e.g. browser URLs such as “about:blank”).

As denoted by step 610 the navigation from the second iFrame address to the first iFrame address is detected by an application running on the device such as device 210. The detection is preferably based on the browser iFrame URL being identified as matching URL#i1 as the browser loads the URL associated with the first iFrame address. At the point that the loading of URL#i1 is detected, indicating that the browser is navigating backwards, the unloading or URL#2 (the second web page address) has not completed, due to the nature of URL#2 being slower to unload than URL#i1 is to load. Thus in step 610 the reloading of the iFrame address URL#i1 is detected by the application running on the device 210.

Following detection of navigation from the second iFrame to the first iFrame address, in step 612, a 3^{rd} party software application associated with the web page is triggered, and launched and enabled. In practice, there may be multiple 3^{rd} party applications associated with the web page, and each may be launched. There may be a set of rules which determines which 3^{rd} party application should be launched in the event that multiple 3^{rd} party applications are identified, or to determine the order in which they should be launched. There may be rules determining whether any third party application is enabled at all.

In step 612 an action associated with a 3^{rd} party software application is executed. In a simple example the 3^{rd} party application provides a user with a message to confirm whether they are sure they want to leave the second address of the web page. The execution of the 3^{rd} party application will be understood by one skilled in the art.

In a step 614, the browser operation to further navigate the backwards operation is then suspended.

In a step 616, a determination is then made as to whether the second address of the web page is still to be closed. This may be, for example, because after the 3^{rd} party software application has asked the user to confirm if they wish to close the web page, they have confirmed the closure or opted not to close the web page.

If it is determined following execution of the 3^{rd} party software application that the second web page should still be closed, then the browser ‘back’ operation continues. In step 618 the browser navigates from the second web page address to the first web page address, and the first web page is loaded in the browser. The web page browser navigates from the second to the first web address.

The page history length remains as 2 with the pointer pointing at URL#1 in sub-field 408a. The browser deletes the iFrame, and the iFrame history parameter 416 is deleted from the browser in step 620. Should the user then select a further forward operation, an iFrame may be recreated in accordance with the above techniques as URL#2 is loaded in the browser and the browser history manipulated as described.

In step 622 the process then ends.

If in step 616 it is determined that the second address of the web page should not be closed, then in step 624 the browser web page is maintained with address URL#2 in sub-field 408b. The browser web page history length remains as 2, with the pointer 401 pointing to URL#2. In one example the above operation to trigger the 3^{rd} party application is configured only to occur once. On the next occurrence of selection of a back operation the above process is therefore not run in this example, and the web page URL#2 simply closed and URL#1 opened.

Thus in step 626 the browser deletes the iFrame, and the iFrame history parameter 416 is deleted from the browser.

In step 628 the process then ends.

This process is based on a simple example of the 3^{rd} party software application, and it being implemented on detection of a back operation. In practice the 3^{rd} party software application may be different.

Thus in accordance with this first technique the history of the browser is manipulated by creating an iFrame on navigating from a first user page address to a second user page address, such that an iFrame history is then created in the browser, and then preferably navigating the iFrame from a first iFrame address to a second iFrame address.

The process of each of FIG. 5 and FIG. 6 may be implemented on a user device, in conjunction with the operation of a browser on the user device. The process may be implemented by software running on the user device, which software is provided to the user device in conjunction with software associated with one or more 3^{rd} party software applications.

In the above example it is described that on navigating the web page to a second address, an iFrame is created and navigated to two iFrame addresses. In the example this permits the reloading of URL#i1 to be detected after URL#i2 has loaded. In other implementations it may be possible to maintain the created iFrame at one address, with a back operation being detected as URL#2 is reloaded as the browser moves back from the iFrame to the second web page on selection of a back operation.

This first technique has been described with the use of an iFrame. In general, this first technique may utilise any HTML document, or document which may be associated with a URL address, in parallel with the web page.

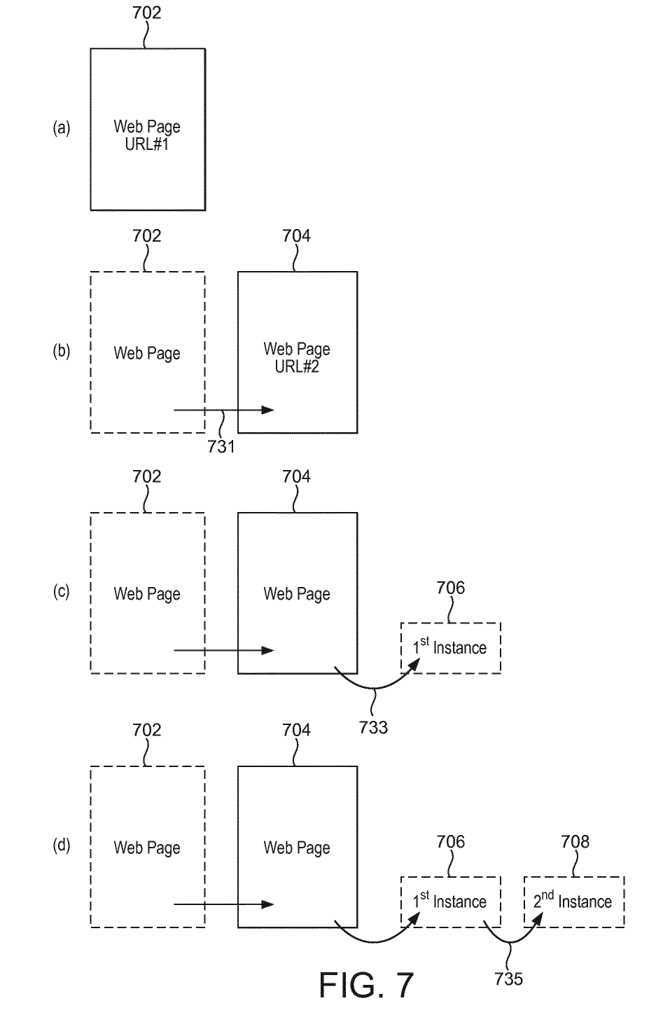

A second technique on determination of a back operation is described with reference to FIGS. 7 to 11.

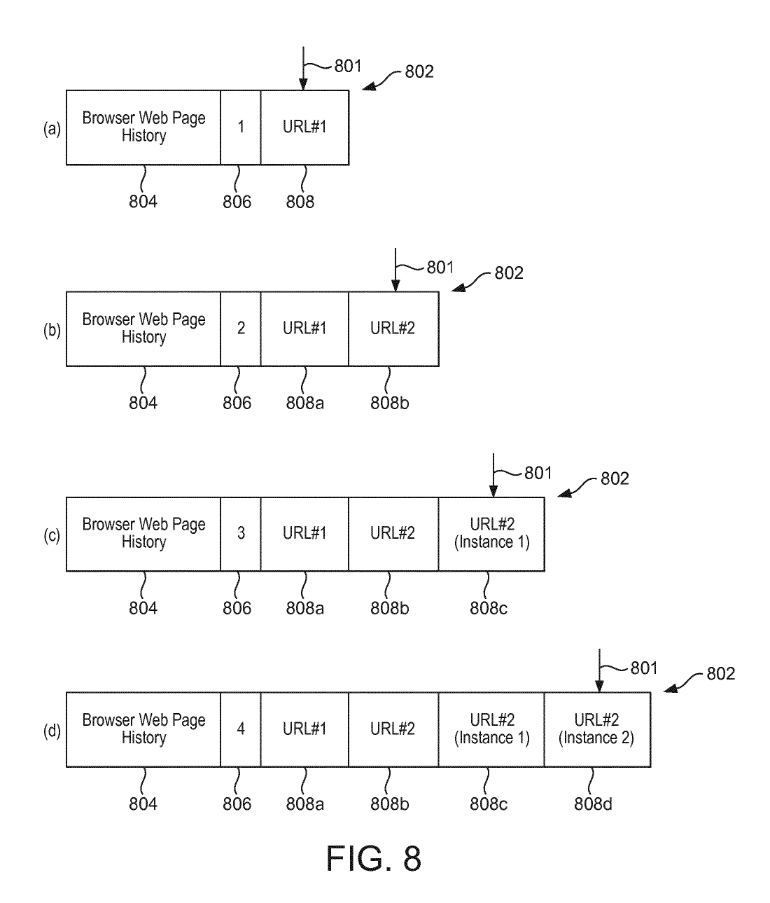

With reference to FIG. 7(a) there is shown a web page 702, having a first web address of URL#1. Referring to FIG. 8(a) there is shown the browser web page history length parameter which is stored by the browser. The browser identifies the browser web page history length by referencing this parameter, and the value with which it is associated. As shown in FIG. 8(a), with the web page open the browser identifies the web page history length as having a value of 1. A browser web page history length parameter 802 has a first field 804 identifying the parameter as a browser web page history length, a second field 806 identifying the history length value (1), and a third field 808 identifying the URL address (URL#1) associated with the history, in this case the URL of the current web page. A pointer denoted by arrow 801 points to the current address of the web page.

On receipt of an instruction from a browser to open a new web page address, which is based on a selection of an option within the current web page, such as a selection of a link within the current web page, a second address for the web page is opened. This is shown in FIG. 7(b).

A web page address 704 having URL#2 is thus opened from URL#1. Thus from a first address of a web page a second address of the web page is opened. The web page 702 at the first address is shown with dashed lines as it has been replaced by the web page 704 at the second address, shown with solid lines.

With reference to FIG. 8(b), the browser web page history length parameter 802 is modified. The browser web page history length parameter 802 has the first field 804 identifying the parameter as browser history length (‘history length’), the second field 806 identifying the history length value (now 2), and a third field 808 identifying the URL addresses associated with the history. There are now two addresses (URL#1, URL#2) associated with the history, and thus the history field 808 has two sub-fields 808a and 808b. The sub-field 808b identifies the current address of the web-page, and the sub-field 808a identifies the previous address of the web-page. The pointer 801 points to sub-field 808b as the current address of the web page. The browser, on selection of the second web page address from the first web page address navigates to this second web page address, whilst the history in the browser is updated in this way.

In addition, a modification is made such that on opening of the web page with the second address further entries are created in the browser web page history, which may be referred to as additional history instances.

These additional history instances are created automatically on navigation from the first web address to the second web address for the user page.

As shown illustratively in FIG. 7(c), a first instance 706 is created. This is illustrated by a dashed box which is linked from the second web page 704. A dashed box is used in this illustration as the presence of this instance is virtual—an entry is added to the browser history, but a browser event does not occur. As shown in FIG. 8(c) the browser web page history length parameter 802 is updated. The first field 804 identifies the parameter as browser web page history length, the second field 806 identifies the browser web page history length as 3, and the third field 808 has an additional sub-field 808c identifying the URL associated with this first instance. The pointer 801 points to this first instance. The URL associated with the first instance is URL#2. The creation of the first instance is simply creation of an additional entry into the browser web page history but the address of the web page does not change.

As shown illustratively in FIG. 7(d), a second instance 708 is created. This is illustrated by a dashed box which is linked from the first instance 704. Again, a dashed box is used in this illustration as the presence of this instance is virtual—an entry is added to the browser history, but a browser event does not occur. As shown in FIG. 8(d) the browser history length parameter 802 is updated. The first field 804 identifies the parameter as browser web page history length, the second field 806 identifies the browser history length as 4, and the third field 808 has an additional sub-field 808d identifying the URL associated with this second instance. The pointer 801 points to this second instance. The URL associated with the second instance is URL#2. The creation of the second instance is simply creation of an additional entry into the browser web page history but the address of the web page does not change.

With reference to FIG. 7(d), it can be seen as denoted by arrow 731 that the second address of the web page is linked from the first address of the web page, as denoted by arrow 733 that the first instance is linked from the web page loaded with the second address, and as denoted by arrow 735 that the second instance is linked from the first instance. Thus a chain is created within the browser web page history.

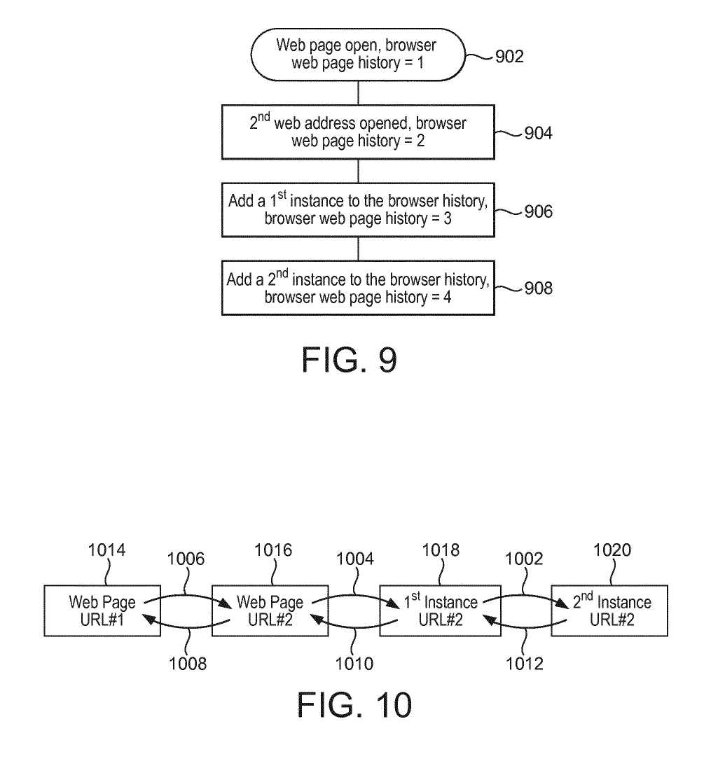

With reference to FIG. 9 there is illustrated the process involved in opening a second web page from a first web page in accordance with this second technique.

In a step 902 the web page is opened with the first address, and the browser web page history is set at 1. In step 904 the second address for the web page is opened, and the browser history is set at 2. Then in step 906 the first instance is created within the web page browser history and the web page browser history set at 3, and in step 908 the second instance is created within the web page browser history, and the web page browser history set at 4. Between steps 904 to 908 the web page remains at address URL#2.

With reference to FIG. 10, there is illustratively shown the links involved in moving back to the first web page address from the second web page address in accordance with this second technique.

FIG. 10 illustratively shows the relationship between the web page history stages, consistent with FIG. 7(d) and FIG. 8(d). Within the browser web page history reference numeral 1014 refers to the web page with the first address (URL#1), reference numeral 1016 refers to the web page with the second address (URL#2), reference numeral 1018 refers to the first instance (referencing address URL#2), and reference numeral 1020 refers to the second instance (referencing address URL#2). The first web page address is forward linked to the second web page address as denoted by reference numeral 1008, the second web page address is forward linked to the first instance as denoted by reference numeral 1010, and the first instance is forward linked to the second instance as denoted by reference numeral 1012. The second instance is backward linked to the first instance as denoted by reference numeral 1002, the first instance is backward linked to the second web page address as denoted by reference numeral 1004, and the second web page address is backward linked to the first web page address as denoted by backward link 1006.

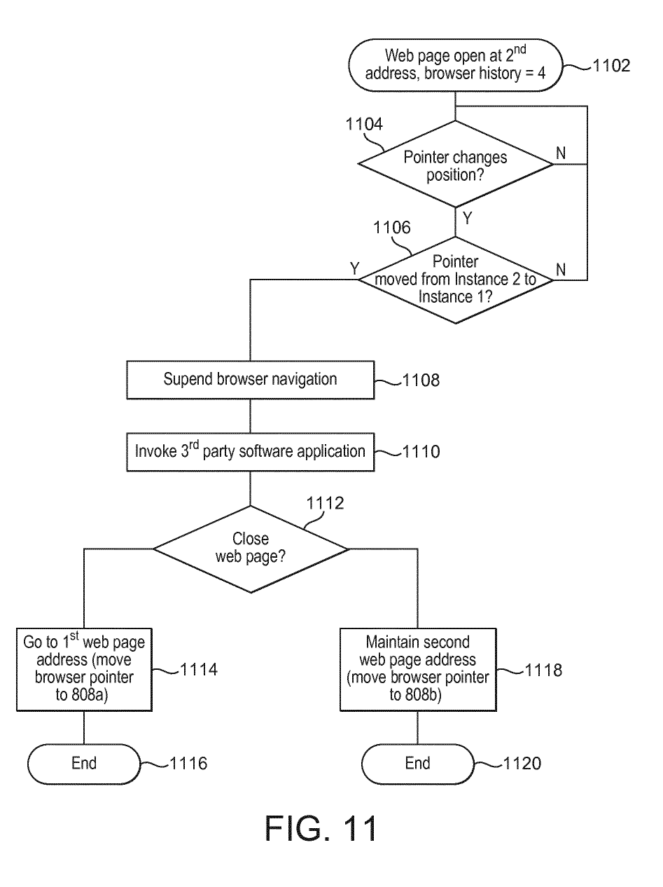

With reference to FIG. 11 there is now illustrated the exemplary process involved in moving back to the first web page address from the second web page address on a back operation in accordance with the second technique.

With reference to FIG. 11, in a step 1102 the second web page is loaded with address URL#2, and the browser web page history is set at 4, with the history pointer pointing at the fourth entry as discussed above. This is the position after the process steps of FIG. 9.

If a back operation is initiated, the browser web page history pointer 801 will move to the third entry (field 808c) from the fourth entry (field 808d), and the URL associated with the first instance loaded—this is the same URL: URL#2. The browser will detect that the pointer 801 is being moved, and determine from this occurrence in combination with the browser history pointer being decremented by 1 that a back operation has been selected.

The operation to move from the second instance to the first instance is denoted by arrow 1002 in FIG. 10.

Referring again to FIG. 11, in a step 1104 a determination is made as to whether the pointer 801 of the web page history has changed position. As long as the pointer does not change position, then the process returns and repeats the monitoring of step 1104.

If it is detected that the pointer has changed position, then in a step 1106 a determination is made as to whether the pointer 801 of the web page history has moved from pointing at Instance 2 to pointing at Instance 1. If it has not, then the process returns to step 1104. If the pointer has moved to point at Instance 1 then it is determined that a back operation has been initiated, and the process moves to step 1108.

In step 1108, after detection of navigation from the second instance to the first instance, browser navigation from the second website address to the first website address is suspended.

Thereafter, in step 1110, a 3^{rd} party software application associated with the second address of the web page is invoked.

In a step 1112 a determination is made as to whether to continue with closing the second web page, following the invoking of the 3^{rd} party software application.

If the web page second address is still to be closed, then in a step 1114 the browser moves from the first instance to the second web page as denoted by arrow 1004 in FIG. 10, and then from the second web page to the first web page, as denoted by arrow 1006. The first web page address is then loaded as the pointer 801 points to the address in field 808a. Thus if the web page address is to be closed, the pointer is moved backwards by two entries, to point at sub-field 808a from pointing at sub-field 808c. On determination that the web page at the second address should be closed, the browser is thus instructed to step back through the history from the second instance to the first web page in this way.

In a step 1116 the process then ends.

If the second web page is not to be closed, then in a step 1118 another action takes place in accordance with the 3^{rd} party software application, which may be for example simply to keep the second web page open. The browser web page history pointer is moved to point to field 808b which is the second address of the web page. On a subsequent ‘back’ operation the above process is not implemented, and the pointer then simply moves from field 808b to field 808a and the first address of the web page is loaded. In an example the operation to trigger the 3^{rd} party application is configured to occur only once, and in FIG. 11. It is assumed that the above operation to run the 3^{rd} party software application occurs only once. In embodiments it may be repeated, or repeated based on a time lapse, and thus in step 1118 the pointer is set to point to field 808d.

The process then ends in step 1120.

The detection of selection of a back operation is preferably detected as a combination of the movement of the pointer in the browser history together with the movement being from the second instance to the first instance (which is identifiable from the browser web page history). Detection of a back operation based on the reloading of the second web page is preferably not utilised, because it could be reloaded for other reasons, for example because it is being updated. Alternatives can be envisaged, and this may also be considered as a single step of detecting decrement of the pointer.

The process of each of FIGS. 8 and 9 may be implemented on a user device, in conjunction with the operation of a browser on the user device. The process may be implemented by software running on the user device, which software is provided to the user device in conjunction with software associated with one or more 3^{rd} party software applications.

Thus in accordance with this search technique the history of the browser is manipulated by creating additional entries in the web page browser history on navigating from a first web page address to a second web page address.

In this second technique it is described that two additional browser web page history instances are created on opening of the second web page address, with the browser history then being increased by 2. This is a preferable implementation, but it would also be possible in certain scenarios to create only one instance and set increase the browser history by 1, and then detect a back operation on detection of navigation from the single created instance to the second web page. However in such an example the detection is dependent on the browser history, and detection by the browser of movement from the single instance to the second web page. This may result in detection of a back operation when in fact there was none. Whilst the described technique may be implemented by creating one instance, preferably two instances are created.

In the above-described arrangement it has been set out that detection of the back-operation is determined by monitoring the behaviour of the pointer operation in the web browser history, and detecting which field the browser is pointing to in order to determine a back operation.

In an alternative, rather than monitoring the pointer activity, names may be monitored. In practice, it may not be possible to determine the pointer location, and thus the names are monitored in order to infer a determination of the pointer location.

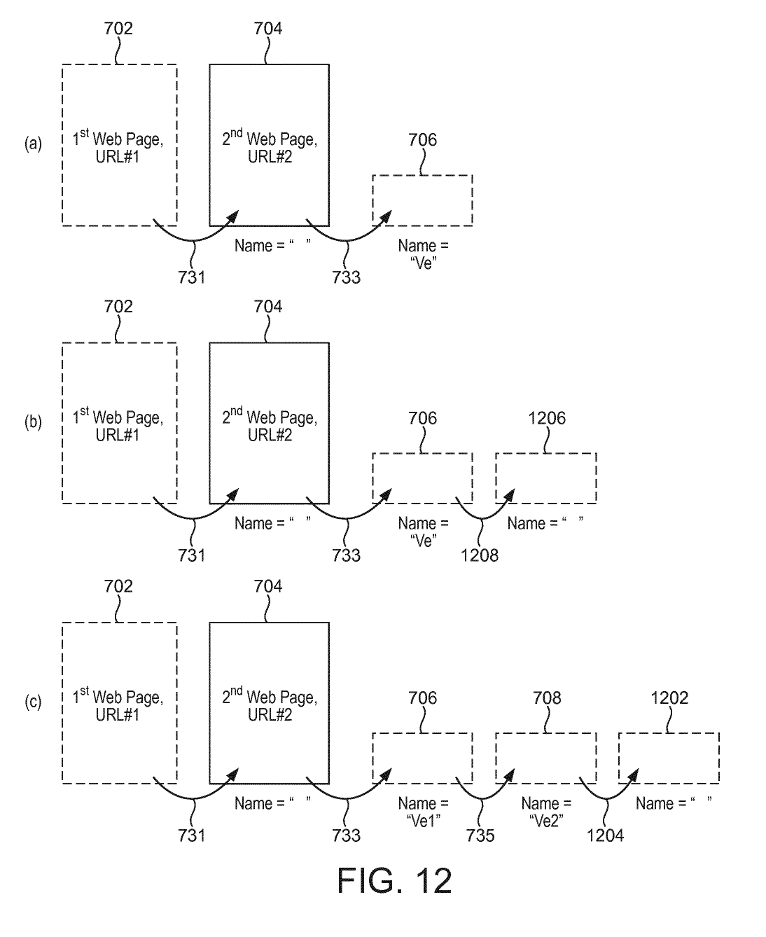

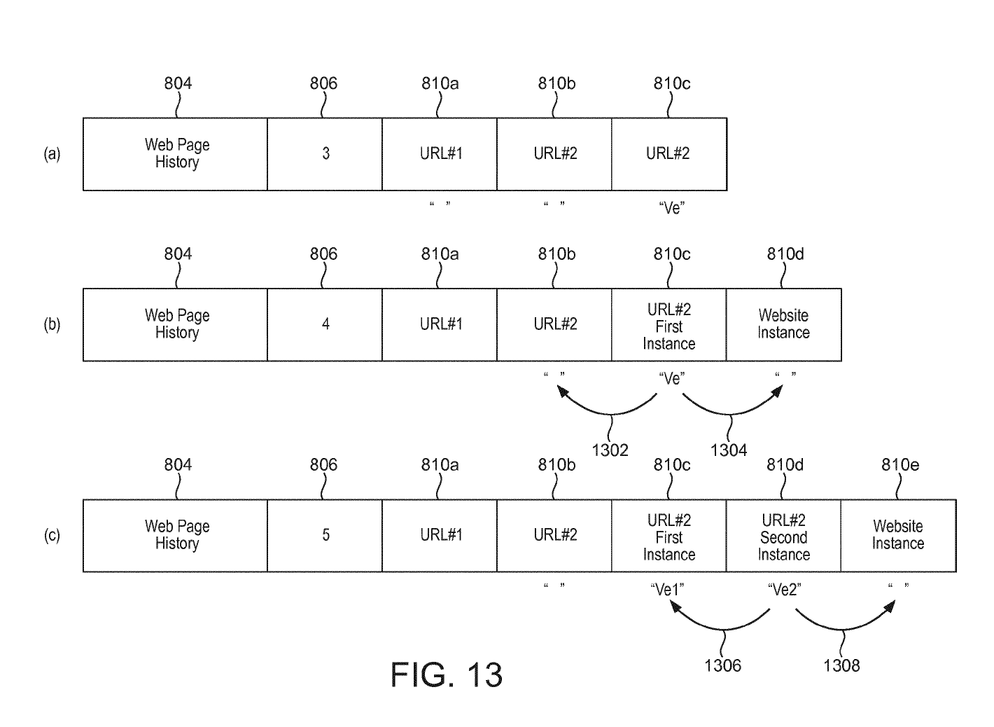

Each field in the browser history is associated with a name. This can be further understood with reference to FIGS. 12 and 13. Where elements shown correspond to elements of earlier figures like reference numerals are used.

With reference to FIG. 12(a), there is shown an example corresponding to FIG. 7(d) but in which one instance rather than two is created on navigating from a first to a second address in a web page. The first address of the web page 702 has link 731 to the second address of the web page 704, and then a single additional instance is created—thus the instance 706 is created, with a link 733 from the second address of the web page 704 to the single instance 706. The web page browser corresponding to FIG. 12(a) is shown in FIG. 13(a).

In FIG. 13(a) the browser web page history 802 includes the field 806 identifying the browser length as 3, a sub-field 810a identifying the address URL#1 (the first address of the web page), a second field 810b identifying the address URL#2 (the second address of the web page), and a third field 810c being associated with the instance 706, and identifying the address URL#2.

As also shown in FIG. 13(a), each field is associated with a name. The names for the first and second web address of the web page in fields 810a and 810b is blank, i.e. the name is “ ”. The name of the created instance in field 810c is “Ve”. This is an example name, and not limiting.

In this example, at some point in time after the navigation to the second web page address, the website creates a further instance itself. Thus as shown in FIG. 12(b) there is created a website instance 1206. Link 1208 shows the link from the instance 706 to the website instance 1206. FIG. 13b shows the modification of the web browser to include this instance as sub-field 810d, with the web page browser history value being increased to 4 in field 806. This additional instance created by the website has a blank name, i.e. “ ” It can be understood with reference to FIG. 13(b) that if the names rather than the pointer location is used to determine browser operation, a problem may arise. If the web browser moves to an address with a blank name (“ ”) from an address with name “Ve”, it will be unclear whether the browser has gone forward or back, since going forward or back from “Ve” moves to a blank name. This can be understood with reference to FIG. 13(b), where it can be seen by arrows 1302 and 1304 that moving from “Ve” to “ ” can be the result of either a forward or back operation.

By creating two instances in accordance with the foregoing described techniques, this issue can be avoided. As shown in FIG. 12(c), the first address of the web page 702 has link 731 to the second address of the web page 704, the first instance 706 is created with a link 733 from the second address of the web page 704 to the first instance 706, and the second instance 708 is created with a link 735 from the first instance to the second instance. As in the arrangement described with reference to FIG. 12(b), after the navigation to the second web page address, the website creates a further instance itself. Thus there is created a website instance 1202. Link 1204 shows the link from the second instance 708 to the website instance 1202. As shown in FIG. 12(c) the name of the second address of the website is blank, i.e. “ ”, and the name of the website instance 1202 is blank, i.e. “ ”. This is consistent with the FIG. 12(b) arrangement. The name of the first instance is, for example, “Ve1”, and the name of the second instance is, for example, “Ve2”.

FIG. 13(c) illustrates the browser web page history 802 for the arrangement of FIG. 12(c). The length is denoted in field 806 as 5. Sub-field 810a denotes the first address URL#1 of the web page having a blank name “ ”, sub-field denotes the second address URL#2 of the web page having a blank name “ ”, sub-field 810b denotes the first instance having the second address URL#2 of the web page and a name “Ve1”, sub-field 810d denotes the second instance having the second address URL#2 of the web page and a name “Ve2”, and sub-field 810e denotes the instance created by the website, having a blank name “ ”.

As can be seen in FIG. 13(c), if the browser moves from the name “Ve2” it will be able to determine whether this is a back or a forward operation: a forward operation will move to a blank name “ ” as denoted by arrow 1308, and a back operation will move to the name “Ve1” as denoted by arrow 1306. The browser can now completely reliably determine whether a back operation or a forward operation is implemented, as the name will change from either “Ve2” to “Ve1” on a back operation, or from “Ve” to “ ” on a forward operation. A back operation can be reliably detected.

In the above-described operation it has been set out that the additional instances to manipulate the browser web page history are created directly after navigation of the web page from the second address to the first address. However, the additional instances associated with this technique may not be the first instances to be added. The website may add an instance itself before these instances.

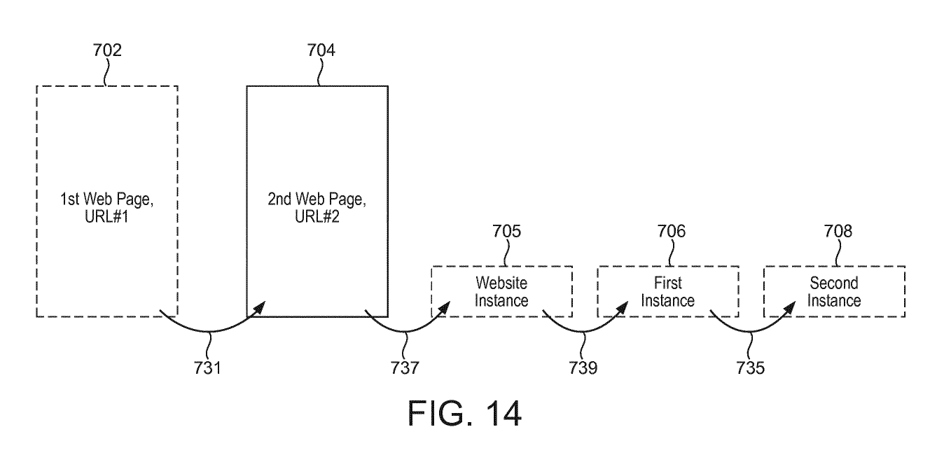

With reference to FIG. 14, there is shown that link 731 links from the first address of the web page 702 to the second address of the web page 704, a link 737 links from the second address of the web page to a website instance 705 created by the browser, link 739 links from the website instance 75 connected by the browser to the first instance named “Ve1” 706, and the link 735 links from the first instance named “Ve1” to the second instance 708 named “Ve2”. The first and second instances 706 and 708 are the instances created in accordance with the above described techniques in order to detect back operation in the browser.

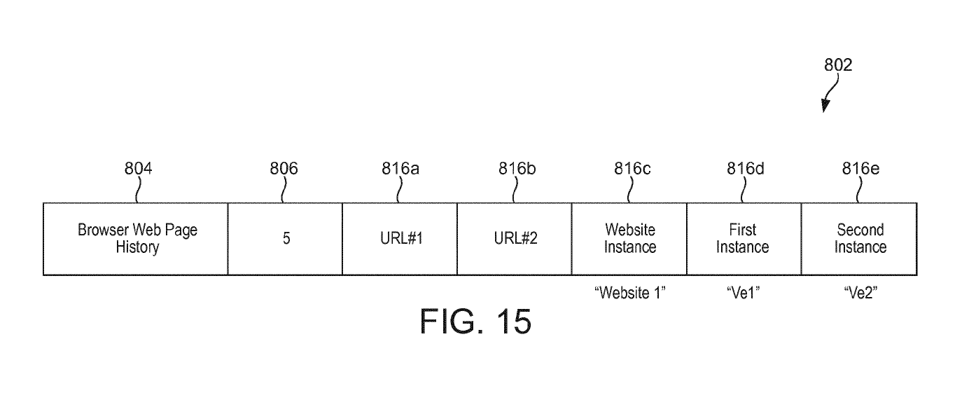

With reference to FIG. 15, the browser web page history 802 associated with FIG. 14 is shown. The browser web page history 802 includes the field 806 identifying the browser length as 5, a sub-field 816a identifying the address URL#1 (the first address of the web page), a second field 816b identifying the address URL#2 (the second address of the web page), a third field 816c being associated with the instance created by the website, a fourth field associated with the virtual first instance “Ve1”, and a fifth filed 816e associated with the virtual second instance “Ve2”.

In accordance with the techniques above, when a back operation is detected, for example by movement from the name “Ve2” to the name “Ve1”, the 3^{rd} party software application is initiated, and one outcome is that the back operation should be completed. In accordance with the above-described techniques, to complete the back operation, and given that two additional instance have been created, the browser will move back two steps through the history from “Ve1”. Thus, for example, in FIG. 8(d) the browser will move two steps from sub-field 808c to sub-field 808a, and the web page address associated with sub-field 808a, i.e. URL#1, will be loaded.

However, in the example of FIGS. 14 and 15, when the browser history is decremented by two, then the address URL#2 associated with the second web page is maintained, and the user will not leave the page. This behaviour is expected as this first history instance 816c has been created by the website and the back button detection should not, in any way, affect the website behaviour.

As discussed above, the back operation may be detected by monitoring the transitions between names, or the states of names. Thus in accordance with the foregoing the state of “Ve2” is monitored.

A browser is able to assign a new name to a state, and therefore may assign a new name to an instance created in the browser according to the described techniques. For example, with reference to FIG. 12(c), the website may change the name of the browser history instances “Ve1” or “Ve2” to something else, such as “website1”. As such, if the detection of the back operation is dependent on monitoring the name of the browser history instances, then if a name is changed by the browser the monitoring of the name must also be changed, to monitor the new name. Thus if the application is currently looking for changes to the state of “Ve2” and the browser changes its name to “website1”, then the application needs to track this change and then detect “website1”. Thus the application is modified to keep track of names and keep the monitoring of names synchronised.

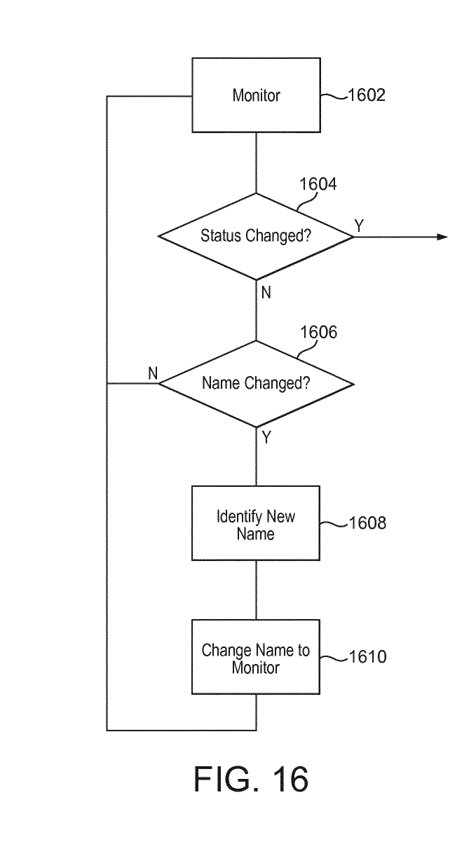

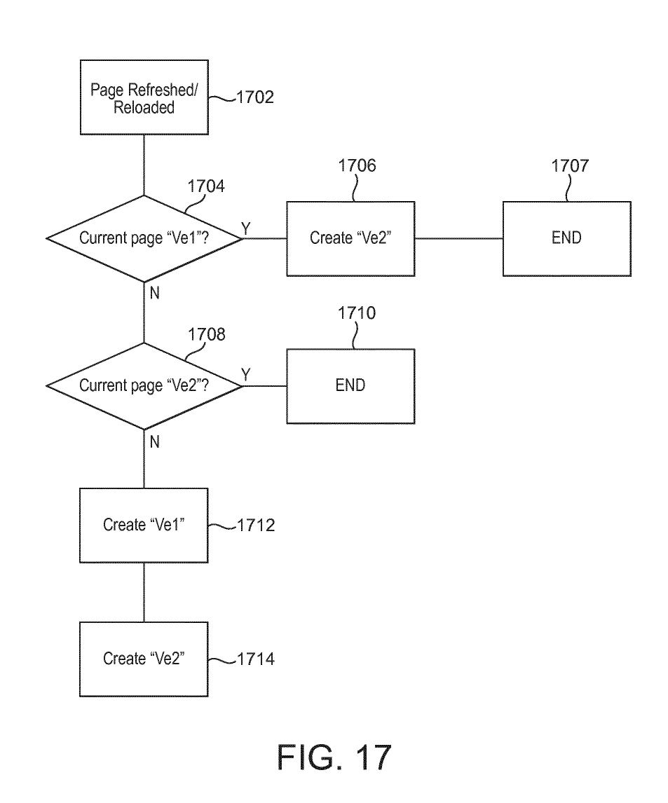

This can be further understood with reference to the flow process of FIG. 16. Once the first and second instances have been created, as noted in step 1602 the state of “Ve2” is monitored. In a step 1604, a step is implemented to determine if the state of “Ve2” is changed. The state may change from, for example, ‘active’ to ‘inactive’ if the browser transitions away from “Ve2”. If the state does change, then the application proceeds to determine whether a back operation is initiated in the browser in accordance with the foregoing techniques.

If the state is not changed, then in step 1606 it is determined if the name of the state being monitored, i.e. “Ve”, has changed. If the name has not changed then the process reverts to step 1602.

If the name has changed, then in a step 1608 the new name is identified, and then in step 1610 the name to monitor is changed. Thus it might be identified that the browser has changed the name of “Ve2” to “website1”, and thus the name “website1” now needs to be monitored. The process then reverts to step 1602.

A further consideration concerns refreshing of addresses by the browser. In order for the preferred implementation of the technique to work it is important to ensure that none of the first and second instances are created when a second address of a web page is navigated to, and so it is important to ensure that any browser refreshing whilst they are being created does not interfere with this. Similarly, it is important to ensure that only the first and second instances are created, and so it is important to ensure that after the first and second instances are created, further refreshing does not result in the generation of further instances.

This can be all accommodated by defining and then applying certain rules.

In accordance with these rules:
1. If a web page is reloaded/refreshed whilst the browser is currently pointing to the first instance (“Ve1”), then the second instance (“Ve2”) is created.
2. If a web page is reloaded/refreshed whilst the browser is currently pointing to the second instance (“Ve2”), no action is taken.
3. If a webpage is reloaded/refreshed whilst the browser is currently pointing to anything other than the first instance (“Ve1”) or the second instance (“Ve2”), then the first (“Ve1”) and second (“Ve2”) instances are created.

If the browser is not pointing to “Ve1” or “Ve2” when the web page is reloaded/refreshed, the browser could be reloading the second address of the web page, or could be reloading a website instance after the second instance “Ve2”.

These rules are further illustrated with reference to FIG. 15.

In a step 1702 a current web pages is refreshed/reloaded. In a step 1704 a determination is made as to whether the current page is associated with “Ve1”. If it is, then in a step 1706 “Ve2” is created, and then in a step 1707 the operation ends.

If in step 1704 it is determined that the current page is not associated with “Ve1”, then in step 1708 a determination is made as to whether the current page is associated with “Ve2”. If it is, then in step 1710 the process ends.

If in step 1708 it is determined that the current page is not associated with “Ve2”, then in step 1712 “Ve1” is created, and then in step “Ve2” is created.

Web pages may be identified as having a common domain. This assumes that a website is identifiable by association with a domain, and the domain identifies the website. Any technique for identifying web pages as being associated with a common website is appropriate.

In the foregoing it is set out that web pages are identified as being associated with a 3rd party software application. In practice a web page may be associated with none, one, or more than one 3rd party software applications. The described technique is concerned with enabling a 3rd party software application when the last web page for a given journey (which may also be a given domain) and associated with that 3rd party software application closes. The web page may be associated, in such circumstances, with more than one 3rd party software application, and more than one 3rd party software application may be enabled. The more than one third software application may comprises multiple applications associated with one 3rd party, or multiple third parties each providing one or more software applications.

In the foregoing description it is described that a 3^{rd} party software application is provided, the 3^{rd} party being a party additional to the user and the party providing the website. However the party providing the website may also provide this ‘3^{rd} party’ software application, in which case there is no 3^{rd} party. In general terms, therefore, there is provided an additional software application, which may be provided by a 3^{rd} party, or may be provided by the party providing the website. There is no limitation as to where the further application providing the functionality described herein is provided from.

In the description, reference to made to the creation of instances in the browser history. A history instance refers to a history state, and where an instance is created, a state is created in the browser history. The term instance is therefore interchangeable with the term state.

In the examples of this description navigation to the second web page address from the first web page address may be as the result of selection of a link displayed on or with the first web page address. However in general the navigation from the first web page address to the second web page address may be the result of any suitable process, and is not limited to this specific technique.

The methods to achieve the described functionality may be implemented as software processes. The software processes described may be implemented on a user device, such as a user computer, user laptop, user tablet, or user smartphone, any of which may be a user mobile device—in general any user device. Such a user device implementing such a process is preferably configured to access a network to allow the user device to load a website, and to allow the user device to access 3^{rd} party software applications associated with the website.

The software processes may be implemented by computer program code. The computer program code may be stored on a user device, or stored accessible to a user device. A computer program product may store computer program code which, when executed, performs a described method. A computer program may comprise code which when executed performs any described method. The computer program code may be transmitted to a new device for execution.

A computer device configured to perform any described method preferably includes a processor and memory. Any browser and browser history is store dim memory, and the memory is updated by a processor. The computer device is provided with an interface to a user.

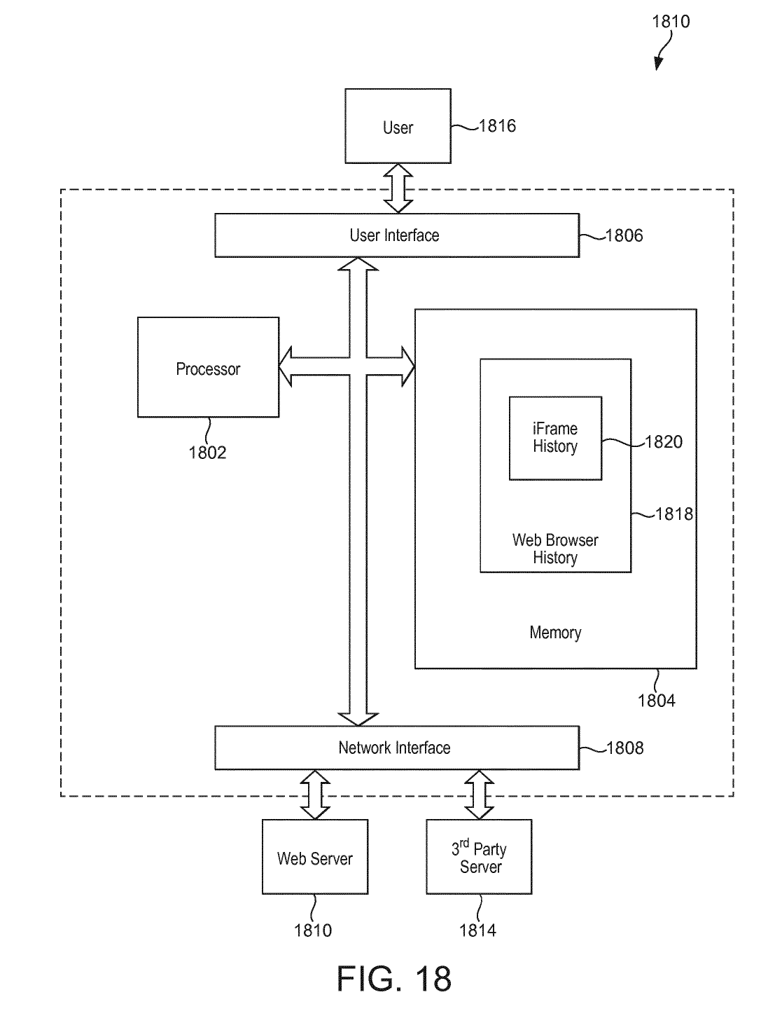

An exemplary computing device 1800 is illustrated in FIG. 18. The computing device includes a user interface 1806, a processor 1802, a memory 1804, and a network interface 1808, all interconnected by communication lines of the computing device.

The user interface 1806 provides an interface to a user1 1816.

The network interface 1808 provides an interface t a web server 1840 and 3^{rd} party server 1814.

The memory 1804 includes a storage 1818 for a web browser history, including a storage 1820 for an optional iFrame history.

The foregoing has set out examples to assist in understanding the invention. The invention is not limited by the details of any example given, nor is the invention limited to any combination of features described.

1.-79. (canceled)

80. A method of controlling a web browser, comprising:
navigating from a first web page address to a second web page address;
manipulating a browser history associated with the web page; and
detecting an operation to navigate back in the manipulated web browser, and in dependence thereon initiating an application associated with the web page.

81. The method of claim 80, wherein the step of manipulating the browser history comprises creating at least one additional browser history entry.

82. The method of claim 80, wherein the step of manipulating a browser history associated with the web page comprises creating an iFrame and an iFrame history for the web page.

83. The method of claim 82 further comprising creating the iFrame at a first address, and navigating the iFrame to a second address.

84. The method of claim 82 further comprising creating the iFrame on navigation of the web page from the first web page address to the second web page address.

85. The method of claim 82, wherein on a back navigation in the web browser, the iFrame loads the first iFrame address.

86. The method of claim 85, wherein detecting the operation to navigate back in the web browser comprises detecting loading of the first iFrame address.

87. The method of claim 82, wherein detecting the operation to navigate back in the web browser comprises detecting navigation of the iFrame from the second iFrame address to the first iFrame address.

88. The method of claim 80, wherein the step of manipulating the browser history associated with the web page comprises creating at least one additional entry in a web page browser history for the web page.

89. The method of claim 88, wherein the step of manipulating the browser history comprises creating two additional history states.

90. The method of claim 89, wherein on a back navigation in the web browser the web page history moves from a second created additional entry to a first created additional entry.

91. The method of claim 80, wherein in response to initiation of the application associated with the web page, the web page is maintained at the second address.

92. The method of claim 80, wherein in response to initiation of the application associated with the web page, the web page is navigated to the first address.

93. The method of claim 80, wherein the step of manipulating a browser history comprises creating an iFrame in dependence on navigation to the second web page address and navigating from a first address of the iFrame to a second address of the iFrame, wherein in dependence on detecting navigation from the second address of the iFrame to the first address of the iFrame, an application associated with the second web page is initiated and wherein the step of navigating to the second web page address from the first web page address increments the web browser history by one, wherein creating the iFrame further comprises the step of creating an iFrame history and the step of navigating the iFrame to a second address further comprising the step of incrementing the iFrame history by one, wherein on initiation of a back operation in the web browser a pointer of the iFrame history is decremented and a pointer of the web browser history is decremented, wherein navigation from the second address of the iFrame to the first address of the iFrame is indicative of a back operation in the web browser, wherein the step of loading the first address of the iFrame denotes navigation from the second address of the iFrame to the first address of the iFrame, wherein a pointer position of an iFrame browser denotes navigation from the second address of the iFrame to the first address of the iFrame, the method further comprising, in dependence on detecting navigation from the second address of the iFrame to the first address of the iFrame, suspending operation of the web browser, wherein initiating the application comprises the step of requesting confirmation that the second web page is to be closed, wherein if such confirmation is provided the method further comprises navigating from the second web page to the first web page, and deleting the iFrame.

94. The method of claim 80, wherein the step of manipulating a browser history comprises sequentially creating at least one further instance in a web page browser history after creation in the web page browser history of an entry for navigation to the second web page address, wherein the step of detecting an operation to navigate back in the manipulated web browser further comprises detecting navigation from the at least one further instance in the web page browser history, and wherein the step of initiating the application associated with the web page further comprises initiating an application associated with the second web page address, and wherein the step of sequentially creating further comprises creating first and second instances in the browser history, the method further comprising:
initiating the application in dependence on detecting navigation from the second instance to the first instance, wherein said navigation is detected in dependence on detecting a browser history pointer changing from pointing to the second instance to pointing to the first instance, wherein a URL associated with the first instance and the second instance is the URL of the second address of the web page, wherein directing navigation from the at least one further instance comprises detecting a change in a web browser pointer position;
detecting that the pointer has moved from pointing to the second instance to pointing to the first instance, wherein on initiation of a back operation the web page is navigated to the first address, wherein the web browser pointer is adjusted to point to the first web page address, wherein on initiation of a back operation the web page is maintained at the second address, wherein a web browser pointer is adjusted to point to the second web page address, wherein the step of detecting navigation from the at least one further instance comprises monitoring the name of the at least one further instance, wherein in dependence on the browser moving from the name of the at least one further instance the application associated with the second web page address is initiated, wherein in dependence on the browser moving from the name of the second instance to a name associated with the first instance the application associated with the second web page address is initiated;
detecting a change to the name of the at least one further instance, and in dependence thereon monitoring the changed name; and
detecting a change to the name of the second instance, and in dependence thereon monitoring the changed name of the second instance, wherein upon the browser refreshing or reloading a web page, if the browser is currently pointing to the first instance, then the second instance is created, wherein upon the browser refreshing or reloading a web page, if the browser is currently pointing to the second instance, no further action is taken, wherein upon the browser refreshing or reloading a web page, if the browser is currently pointing to anything other than the first or second instance, then the first instance is created followed by the second instance being created.

95. A non-transitory computer program which, when executed on a computer, performs the steps of:
navigating from a first web page address to a second web page address;
manipulating a browser history associated with the web page; and
detecting an operation to navigate back in the manipulated web browser, and in dependence thereon initiating an application associated with the web page.

96. A computer device configured to:
navigate from a first web page address to a second web page address;
manipulate a browser history associated with the web page; and
detect an operation to navigate back in the manipulated web browser, and in dependence thereon initiating an application associated with the web page.

97. The computer device of claim 96 configured to manipulate the browser history by creating at least one additional browser history entry.

98. The computer device of claim 96 configured to manipulate a browser history associated with the web page by creating an iFrame and an iFrame history for the web page, configured to create the iFrame at a first address, and navigate the iFrame to a second address, configured to create the iFrame on navigation of the web page from the first web page address to the second web page address, configured to, on a back navigation in the web browser, load the first iFrame address, configured to detect the operation to navigate back in the web browser by detecting loading of the first iFrame address, configured to detect the operation to navigate back in the web browser by detecting navigation of the iFrame from the second iFrame address to the first iFrame address.

99. The computer device of claim 96 configured to manipulate the browser history associated with the web page by creating two additional web page browse histories, configured to, on a back navigation in the web browser, move the web page history from a second created additional entry to a first created additional entry, configured to, in response to initiation of the application associated with the web page, maintain the web page at the second address, configured to, in response to initiation of the application associated with the web page, navigate the web page to the first address.
